(19) United States
(12) Patent Application Publication
(10) Pub. No.: US 2010/0285313 A1
(43) Pub. Date: Nov. 11, 2010

(54) MICROENCAPSULATED FIRE RETARDANTS AND THE USES THEREOF

(75) Inventors: Xiaoyan Zhang, BEIJING (CN); Ning Zhao, BEIJING (CN); Xiaoli Zhang, BEIJING (CN); Jian Xu, BEIJING (CN)

Correspondence Address: SHIMOKAJI & ASSOCIATES, P.C., 8911 RESEARCH DRIVE, IRVINE, CA, 92618, US

(73) Assignee: ETERNAL CHEMICAL CO., LTD., KAOHSIUNG (TW)

(21) Appl. No.: 12/777,146

(22) Filed: May 10, 2010

(30) Foreign Application Priority Data
May 11, 2009 (CN) 200910083945.3

(51) Int. Cl. C09K 21/00; B05D 3/00; B32B 5/02

(52) U.S. Cl. 428/376; 252/601; 252/604; 427/299

(57) ABSTRACT

The present invention pertains to a microencapsulated fire retardant and the uses thereof. The inventive micro-encapsulated fire retardant comprises a core containing a fire retardant and a shell of a natural microtubule, wherein the core is encapsulated by the shell. The microencapsulated fire retardant of the present invention can be composited into a certain polymeric substrate by a mixing method so as to form into a corresponding, fire-retardant polymeric composite material.

### BACKGROUND OF INVENTION

1. Field of the Invention

The present invention relates to a microencapsulated fire retardant and the uses thereof.

2. Description of the Prior Art

To meet the needs of safe production and living and of fire prevention, fire retardant technology was developed to protect people lives and property. Fire retardant, also known as flame retardant agent or fire-resistant agent, is a practical application of such technology. Fire retardant is a special chemical engineering aid for modifying the combustion properties of flammable or combustible materials, and has been widely utilized in the fire-resistant processing of various decorating and building materials. Fire retardant can be used in various fields such as chemical building materials, electronic and electric devices, communication and transportation, interior decoration, food, clothing, and housing, and can prevent plastic products, fabrics, rubbers, paper products, adhesives, and wood products from catching fire or delay the spread of fire. With the increasing amount of plastic products used in building, packaging, communications, transportations, electronics, electrical products, furniture, and clothing, the combustion problems of plastic products are attracting more and more attention in every country. In addition to plastics containing a halogen such as fluorine or chlorine, polymers composed of carbon, hydrogen, and oxygen are also flammable to some extent. When these plastics are burnt, they produce not only raging fire but smoke and poisonous gas. Accordingly, suitable fire retardant should be chosen on the basis of its compatibility with resin, fire retardant efficiency, and cost. If a material is processed with a fire retardant, the ignition time of the material can be effectively prolonged when it is attacked by a fire source, or, if the material is ignited, the fire can be self-extinguished, so that the spread of fire can be effectively prohibited, delayed, or terminated and a fire retardant effect can be achieved. Nevertheless, practical utilizations of fire retardants are fraught with problems such as difficulty in processing, intolerability in transport, easy isolation on the material surface, moisture absorption, hydrolysis, tendency to expand and generating gas bubbles during the processing of the material, difficulty in recycling, and poor weather resistance.

Microencapsulation is a technique that coats material particles with a stable polymer or inorganic substance so as to form a core-shell structured composite material. With the developments in polymer science, the microencapsulation technique is gradually becoming mature. Therefore, more attention and research have been focused on microcapsules encapsulating various materials with particular properties and uses, in particular microcapsules that have a liquid in the core and a solid polymeric film as the shell. These microcapsules are in the form of solid particles with a shell material to protect the core liquid from the environment so as to stabilize the core liquid. Meanwhile, the polymeric shell material or a modified shell material greatly enhances the compatibility of the encapsulated material with a substrate material. Consequently, microencapsulated materials can effectively solve the serious problems associated with easy penetration, migration and phase separation and increase the practicability of fire retardant materials. However, the strength, penetration properties, and heat resistance of the walls of the microcapsules all need to be improved, and because of their high cost, lowering the production cost of microcapsules would be the key to making the microencapsulation technique practical.

### SUMMARY OF THE INVENTION

Accordingly, the present invention is directed to a microencapsulated fire retardant that utilizes truncated microtubules having micro-pores and a large specific surface area as a support material to absorb via capillary absorption a liquid of a fire retardant agent into the micro-pores to form fire retardant microtubules. Due to the capillary force, the absorbed liquid of the fire retardant agent will not easily overflow from the micropores. Then a polymer is used to further close and terminate the fire retardant microtubules so as to further prevent the liquid of the fire retardant agent from flowing out from the microtubules. The support material for the microencapsulated fire retardant according to the present invention is natural microtubules which are cheap and easy to obtain.

In addition, since the inventive microencapsulated fire retardants are in the form of particles, they can be more uniformly distributed in a substrate material during a practical processing procedure. The microencapsulated fire retardants have a micro-level size and will not affect the appearance of the product. Moreover, the microencapsulated fire retardants have a certain aspect ratio, and can impart micro-fibrous reinforcement to the substrate material and enhance the mechanical properties of the substrate material, thereby providing the resultant polymeric composite material with high fire resistance and mechanical properties.

In order to achieve the above purposes, the present invention provides a microencapsulated fire retardant comprising a core and a shell for encapsulating the core wherein the core comprises a fire retardant agent and the shell is a natural microtubule.

Another object of the present invention is to provide a method for producing a microencapsulated fire retardant. Yet another object of the present invention is to provide a fire-retardant polymeric composite material comprising the inventive microencapsulated fire retardant and a polymeric substrate material.

### DETAILED DESCRIPTION OF THE INVENTION

The microencapsulated fire retardant agent according to the present invention comprises a core comprising a fire retardant and a shell of a natural microtubule for encapsulating said core.

The species of the fire retardant agent suitable for the inventive microencapsulated fire retardant are not particularly limited and can be, for example, decabromo-diphenylether, tetrabromo bisphenol A (TBA), octabromoether (BDDP), decabromo-diphenyl ethane, tetrabromoether, bromo polystyrene, hexabromo-cyclododecane (HBCD), chlorinated paraffin, Dechlorane Plus, chlorinated polyethylene (CPE), decabromo diphenyl ether, octabromo diphenyl ether, pentabromo diphenyl ether, 2,2-di(chloromethyl)cyclopropane (V-6), ammonium chloride, bromo epoxy resin, dibromo-neopentyl-glycol (DBNPG), dibromo-neopentyl-glycol phosphate, dibromo-neopentyl-glycol phosphate cyanamide, hexabromo cyclododecane (HBCD), tribromo phenol, tetrabromo phthalic anhydride, bis(2,3-dibromopropyl)fumarate, phenoxy tetrabromo bisphenol A carbonate, 1,2,3,4-tetrabromo butane, (2,3-dibromopropyl)fumarate-1,3-bis(2,4,6-tribromo-phenoxy)isopropanol, antimony trichloride, 1,2-bis(2,4,6-tribromophenoxy)ethane, 4,4′-isopropylidene bis(2,6-dibromophenol), 2,3-dibromo-1-propanol, an unsaturated ester of tetrachloro phthalic anhydride, phenoxy tetrabromo bisphenol A carbonate oligomer, bis(2,3-dibromopropyl) fumarate, red phosphorus, tri(2-chloroethyl)phosphate (TCEP), tri(2-chloropropyl)phosphate (TCPP), tri(2,3-dichloropropyl)phosphate , (TDCP), mono-ammonium phosphate, di-ammonium phosphate, triphenyl phosphate, ExolitOP1311, ExolitOP1312M1, Exolit RP, ammonium polyphosphate (APP), pentaerythritol, melamine phosphate (MP), tri(2,3-dibromopropyl)phosphate, tetrakis(hydroxymethyl)phosphonium chloride (THPC), cyclic phosphate derivatives, phosphorus-containing polyol polyether, tri(chloroethyl)phosphate, zinc phosphate, trimethyl phosphonate, trimethyl phosphate, guanidine phosphate, ammonium dihydrogen phosphate, diammonium hydrogen phosphate, tribenzyl phosphate, melamine polyphosphate (salt) (MPP), FR-108, FR-808, FR-NP, triphenylphosphine (TPP), ethylene di(tetrabromo phthalimide), tri(β-chloroethyl)phosphate (TCEP), dimethyl methylphosphate (DMMP), tri(bromophenyl)phosphate (PB-460), DG-9021, melamine and the salts thereof (MC, MA), dicyanamide, guanidine salts, melamine phosphate salts, melamine cyanurate (MCA), magnesium hydroxide, aluminum hydroxide, antimony(III) oxide, zinc borate, low hydrate zinc borate, ferrocene, boric acid, tri(2,3-dibromopropyl)isocyanurate (TBC), FB((2ZnO.3B₂O₃.3.5H₂O)), hexabromo cyclododecane (HBCD), melamine cyanurate (MCA), isopropyl phenyl diphenyl phosphate (IPPP), flame retardant FR2003, Poly(phenylene oxide) (PPO), poly(tetrafluoro ethylene) fine powder, hydrotalcite, Reogard1000, flame retardant SaFRon, FlamestabNOR116, Tin2uviFR, brucite, organic soil, flame retardant ATH, RDP, Firebrake 415, Firebrake 500, BT-93W, FRC-1, TLG-512, 3031, cotton fabric flame retardant CP, diisopropyl benzene oligomer, sodium antimonate, calcium chloride, FR-303, FR-508A, FR-508B, FR-707, FR-708, FR-P, or FR-N, or a mixture thereof.

Natural fibers that are suitable for the microencapsulated fire retardant of the invention can be selected from kapok fiber, milkweed fiber, luffa fiber, bamboo fiber, tex bamboo fiber, flax fiber, wool, and down. According to an embodiment of the present invention, the natural fibers are mechanically truncated into natural microtubules with a length of 10 μm˜1 cm. According to one embodiment of the present invention, the natural microtubules are obtained from kapok fiber. Kapok fiber is a natural fiber having a large specific surface area and a high hollowness up to 80-90%, which is difficult to be realized by current artificial preparation methods, thus being more suitable for manufacturing encapsulation material than man-made fibers. Further, kapok fiber has a high thermo-stability and substantially will not be thermally degraded at 250° C. Also, kapok fiber has a high chemical stability, and will only be dissolved in high-concentration strong acids. Further, its special lipophilic and hydrophobic wetting properties can be utilized during a processing method.

The microencapsulated fire retardant of the present invention utilizes natural microtubules as a support material to absorb via capillary absorption a liquid of a fire retardant agent into the micro-pores to form fire retardant microtubules. Due to the capillary force, the absorbed liquid of the fire retardant agent will not easily overflow from the micropores. According to a preferred embodiment of the present invention, the microencapsulated fire retardant of the invention optionally comprises an encapsulation layer for encapsulating said fire-retardant microtubules so as to close and terminate the fire-retardant microtubules and further address the flowing problem associated with the fire retardant liquid. According to the present invention, the encapsulation layer for encapsulating the microencapsulated fire retardant can be formed from a synthetic polymer or natural fiber. Suitable synthetic polymers are not particularly limited, and may include, for example, but are not limited to, polyethylene, polypropylene, polybutylene, polystyrene, polyvinyl chloride, polyisobutylene, polyacrylonitrile, polyurethane, polymethyl methacrylate, polymethyl acrylate, polyvinyl acetate, polyethylene terephthalate (PET), polybutylene terephthalate, alkyd resin, polycarbonate, urea-formaldehyde resin, melamine-formaldehyde resin, melamine-urea-formaldehyde resin, phenolic resin, epoxy resin, polyoxymethylene (POM), polyethylene oxide, polyphenylene sulfide, hexamethylene adipamide polymer, polycaprolactam, polyimide, polydimethyl siloxane, acrylonitrile-butadiene-styrene(ABS) copolymer, styrene-butadiene-styrene block copolymer (SBS), isobutylene-isoprene rubber (IIR), or butadiene-isoprene copolymer (PIB), or a mixture thereof. Suitable natural fibers for the encapsulation layer are not particularly limited, and may include, for example, but are not limited to, cotton fiber, bast fiber, xylem fiber, grass fiber, or acetate fiber, or a mixture thereof. According to a preferred embodiment of the present invention, the encapsulation layer of the microencapsulated fire retardant is formed from urea-formaldehyde resin, acetate fiber, polyacrylonitrile, phenolic resin, polyethylene terephthalate, polyphenylene sulfide, or alkyd resin or a mixture thereof.

According to the present invention, the method for producing the microencapsulated fire retardant comprises using natural microtubules to absorb a fire retardant agent and optionally encapsulating the natural microtubules that have absorbed the fire retardant agent with a synthetic polymer or a natural fiber to produce the microencapsulated fire retardant.

The present invention further provides a fire-retardant polymeric composite material comprising the above-mentioned microencapsulated fire retardant and a polymeric substrate material. The fire-retardant polymeric composite material can be prepared by a process comprising composing the microencapsulated fire retardant with a certain polymeric substrate material by a mixing method so as to produce the corresponding fire-retardant polymeric composite material.

The inventive microencapsulated fire retardants have a micro-level size and can be uniformly distributed in the substrate material without affecting the appearance of the product. Moreover, the microencapsulated fire retardants have certain aspect ratios, and can impart micro-fibrous reinforcement to the substrate material and enhance the mechanical properties of the substrate material, thereby providing the resultant polymeric composite material with high fire resistance and high mechanical strength.

The polymeric substrate materials suitable for the present invention are not particularly limited and may include, for example, but are not limited to, polyolefin resin such as polyethylene (PE), polypropylene (PP), polyisobutylene or poly n-butylene; poly(meth)acrylate ester, such as polymethyl methacryalte (PMMA) or polymethyl acrylate; polyester such as polyethylene terephthalate or polybutylene terephthalate; polystyrene; polyvinyl chloride; polyacrylonitrile; polyurethane; polyvinyl acetate; polycarbonate; urea-formaldehyde resin; melamine-formaldehyde resin; melamine-urea-formaldehyde resin; phenolic resin; epoxy resin; polyoxymethylene (POM); polyethylene oxide; hexamethylene adipamide polymer (PA66); polycaprolactam; polyimide; polydimethyl siloxane; acrylonitrile-butadiene-styrene(ABS) copolymer; styrene-butadiene-styrene block copolymer (SBS); isobutylene-isoprene rubber (IIR); or butadiene-isoprene copolymer (PIB), or a mixture thereof. According to a preferred embodiment of the present invention, the polymeric substrate material is selected from phenolic resin, polyacrylonitrile, epoxy resin, polymethyl methacrylate, polystyrene, polyurethane, butadiene-isoprene copolymer, hexamethylene adipamide polymer, polycarbonate, polypropylene, polyoxymethylene, and styrene-butadiene-styrene block copolymer, and a mixture thereof.

The invention will be further illustrated by the following examples. Unless described otherwise, all the processes used are normal ones and all the reagents utilized are commercially available.

### EXAMPLES

### Example 1

### Preparation of Encapsulated Microencapsulated Fire Retardant

(1) Preparing Truncated Microtubules:

Truncate 1 g natural kapok fiber into truncated microtubules having a length of 50-200 μm.

(2) Filling Natural Microtubules with a Fire Retardant Liquid:

The truncated microtubules obtained in step (1) were dispersed and immersed in the fire retardant RDP liquid (Zhejiang Wansheng Chemical Co., Ltd, trade name: WSFR) for 0.5 hours to make the absorption of the fire retardant liquid to the microtubules reach a balance, such that the truncated microtubules were fully filled with the fire retardant liquid, thereby producing fire-retardant microtubules 1.

(3) Encapsulating the Fire-Retardant Microtubules 1:

2 g urea-formaldehyde prepolymer (obtained by adding 1 g urea into 2 ml 36% volume fraction aqueous formaldehyde solution and stirring until the mixture was fully dissolved, heating to 60° C., and maintaining at this temperature for 15 min) was directly added dropwise into the fire-retardant microtubules 1 obtained in Step (2), the temperature of the mixture was raised to 97-98° C. and the reaction lasted for 1 h. Urea-formaldehyde resin polymer was generated around the kapok fiber through phase separation and deposition, such that the fire-retardant microtubules 1 were encapsulated by the urea-formaldehyde resin, thereby obtaining encapsulated microencapsulated fire retardant 1.

### Preparation of Fire-Retardant Polymeric Composite Material

The encapsulated microencapsulated fire retardant 1 was blended with polyurethane in a ratio of 1:10 by weight in a 30% (weight percentage) solution of polyurethane in N,N′-dimethyl foramide, thereby being coated and formed into fire-retardant polymeric composite material 1.

The limiting oxygen index (LOI) for each of the pure polyurethane (A), the polyurethane containing Kapok tubules (B), the polyurethane with directly added RDP (C), and the resultant fire-retardant polymeric composite material 1 (D) and the results of plastic fire retardation test (UL-94) are shown in the following Table 1.

It can be seen from the results of the test, both the polyurethane with directly added RDP and the resultant fire-retardant polymeric composite material 1 have a significantly enhanced fire retardation performance as compared with the pure polyurethane. The fire retardation properties of the encapsulated microencapsulated fire retardant 1 are not adversely affected and the problems associated with penetration, migration, and phase-separation during an application process can be addressed.

### Example 2

### Preparation of Encapsulated Microencapsulated Fire Retardant

(1) Preparing Truncated Microtubules:

Truncate 1 g natural kapok fiber into truncated microtubules having a length of 200 μm˜2 mm.

(2) Filling Natural Microtubules with a Fire Retardant Liquid:

The truncated microtubules obtained in step (1) were dispersed and immersed in a 90% (weight percentage) ethanol solution of red phosphorus for 0.5 hours to make the capillary absorption of the fire retardant liquid to the microtubules reach a balance, such that the truncated microtubules were fully filled with the ethanol solution of red phosphorus, thereby producing fire-retardant microtubules 2.

(3) Encapsulating the Fire-Retardant Microtubules 2:

The ethanol in the fire-retardant microtubules 2 was evaporated. The resultant fire-retardant microtubules 2 were immersed in 5 ml 5% by weight of a dichloromethane solution of acetate fiber and the reaction lasted for 1 min. Acetate fiber was generated around the kapok fiber by deposition, such that the fire-retardant microtubules 2 were encapsulated by the acetate fiber, thereby obtaining encapsulated microencapsulated fire retardant 2.

### Preparation of Fire-Retardant Polymeric Composite Material

The encapsulated microencapsulated fire retardant 2 was blended with polyacrylonitrile in a ratio of 1:20 by weight in a 30% (weight percentage) solution of polyacrylonitrile in dimethyl acetamide, and dried at 60° C. to evaporate the solvent thereby obtaining fire-retardant polymeric composite material 2.

The limiting oxygen index (LOI) for each of the pure polyacrylonitrile (A), the polyacrylonitrile containing Kapok tubules (B), the polyacrylonitrile with directly added red phosphorus (C), and the resultant fire-retardant polymeric composite material 2 (D) and the results of plastic fire retardation test (UL-94) are shown in the following Table 2.

It can be seen from the results of the test, the fire retardation properties of the encapsulated microencapsulated fire retardant 2 are not adversely affected and the problems associated with penetration, migration, and phase-separation during using process can be addressed.

### Example 3

### Preparation of Encapsulated Microencapsulated Fire Retardant

(1) Preparing Truncated Microtubules:

Truncate 1 g natural milkweed fiber into truncated microtubules having a length of 2˜10 mm.

(2) Filling Natural Microtubules with a Fire Retardant Liquid:

The truncated microtubules obtained in step (1) were dispersed and immersed in a 80% (weight percentage) methanol solution of melamine for 0.5 hours to make the capillary absorption of the methanol solution of melamine to the microtubules reach a balance, such that the truncated microtubules were fully filled with the methanol solution of melamine, thereby producing fire-retardant microtubules 3.

(3) Encapsulating the Fire-Retardant Microtubules 3:

The methanol in the fire-retardant microtubules 3 was evaporated. The resultant fire-retardant microtubules 3 were immersed in 5 ml 5% by weight of an N,N′-dimethyl foramide solution of polyacrylonitrile and the reaction lasted for 10 min. The fire-retardant microtubules were encapsulated with the polyacrylonitrile by surface deposition, thereby obtaining encapsulated microencapsulated fire retardant 3.

### Preparation of Fire-Retardant Polymeric Composite Material

The encapsulated microencapsulated fire retardant 3 was blended with polyurethane in a ratio of 1:5 by weight in a 30% (weight percentage) solution of polyurethane in N,N′-dimethyl foramide, and dried at 80° C. to evaporate the solvent thereby obtaining fire-retardant polymeric composite material 3.

The limiting oxygen index (LOI) for each of the pure polyurethane (A), the polyurethane containing milkweed tubules (B), the polyurethane with directly added melamine (C), and the resultant fire-retardant polymeric composite material 3 (D) and the results of plastic fire retardation test (UL-94) are shown in the following Table 3.

It can be seen from the results of the test, the fire retardation properties of the encapsulated microencapsulated fire retardant 3 are not adversely affected and the problems associated with penetration, migration, and phase-separation during using process can be addressed.

### Example 4

### Preparation of Encapsulated Microencapsulated Fire Retardant

(1) Preparing Truncated Microtubules:

Truncate 1 g natural flax fiber into truncated microtubules having a length of 50˜100 μm.

(2) Filling Natural Microtubules with a Fire Retardant Liquid:

The truncated microtubules obtained in step (1) were dispersed and immersed in a ammonium polyphosphate liquid for 0.5 hours to make the capillary absorption of the ammonium polyphosphate to the microtubules reach a balance, such that the truncated microtubules were fully filled with the ammonium polyphosphate, thereby producing fire-retardant microtubules 4.

### (3) Encapsulating the Fire-Retardant Microtubules 4:

The fire-retardant microtubules 4 were immersed in 5 ml 5% by weight of a dichloromethane solution of acetate fiber. The fire-retardant microtubules were encapsulated with the acetate fiber by surface deposition, thereby obtaining encapsulated microencapsulated fire retardant 4.

### Preparation of Fire-Retardant Polymeric Composite Material

The encapsulated microencapsulated fire retardant 4 was blended with phenolic resin in a ratio of 1:20 by weight in a 90% (weight percentage) solution of phenolic resin in ethanol, and dried at 60° C. to evaporate the solvent thereby obtaining fire-retardant polymeric composite material 4.

The limiting oxygen index (LOI) for each of the pure phenolic resin (A), the phenolic resin containing flax tubules (B), the phenolic resin with directly added ammonium polyphosphate (C), and the resultant fire-retardant polymeric composite material 4 (D) and the results of plastic fire retardation test (UL-94) are shown in the following Table 4.

It can be seen from the results of the test, the fire retardation properties of the encapsulated microencapsulated fire retardant 4 are not adversely affected and the problems associated with penetration, migration, and phase-separation during using process can be addressed.

### Example 5

### Preparation of Encapsulated Microencapsulated Fire Retardant

(1) Preparing Truncated Microtubules:

Truncate 1 g natural kapok fiber into truncated microtubules having a length of 10˜50 μm.

(2) Filling Natural Microtubules with a Fire Retardant Liquid:

The truncated microtubules obtained in step (1) were dispersed and immersed in a 60% (weight percentage) methanol solution of tetrabromo bisphenol A (TBA) for 0.5 hours to make the capillary absorption of the tetrabromo bisphenol A (TBA) to the microtubules reach a balance, such that the truncated microtubules were fully filled with the tetrabromo bisphenol A (TBA), thereby producing fire-retardant microtubules 5.

(3) Encapsulating the Fire-Retardant Microtubules 5:

The methanol in the fire-retardant microtubules 5 was evaporated and the resultant fire-retardant microtubules were immersed in 5 ml 5% by weight of a dichloromethane solution of acetate fiber. The fire-retardant microtubules were encapsulated with the acetate fiber by surface deposition, thereby obtaining encapsulated microencapsulated fire retardant 5.

### Preparation of Fire-Retardant Polymeric Composite Material

The encapsulated microencapsulated fire retardant 5 was blended with bisphenol A and epoxy chloropropane in a ratio of 1:8:1 by weight in a mixture liquid of bisphenol A and epoxy chloropropane. A prepolymer was obtained under the catalysis with NaOH, and then crosslinked with an equivalent amount of ethylene diamine at room temperature so as to obtain a fire-retardant polymeric composite material 5 with an epoxy resin as the polymeric substrate material.

The limiting oxygen index (LOI) for each of the pure epoxy resin (A), the epoxy resin containing kapok tubules (B), the epoxy resin with directly added tetrabromo bisphenol A (C), and the resultant fire-retardant polymeric composite material 5 (D) and the results of plastic fire retardation test (UL-94) are shown in the following Table 5.

It can be seen from the results of the test, the fire retardation properties of the encapsulated microencapsulated fire retardant 5 are not adversely affected and the problems associated with penetration, migration, and phase-separation during using process can be addressed.

### Example 6

### Preparation of Encapsulated Microencapsulated Fire Retardant

(1) Preparing Truncated Microtubules:

Truncate 1 g natural milkweed fiber into truncated microtubules having a length of 100˜500 μm.

(2) Filling Natural Microtubules with a Fire Retardant Liquid:

The truncated microtubules obtained in step (1) were dispersed and immersed in a 60% (weight percentage) ethanol solution of chlorinated polyethylene (CPE) for 0.5 hours to make the capillary absorption of the ethanol solution of chlorinated polyethylene to the microtubules reach a balance, such that the truncated microtubules were fully filled with the fire retardant liquid, thereby producing fire-retardant microtubules 6.

(3) Encapsulating the Fire-Retardant Microtubules 6:

The fire-retardant microtubules 6 were immersed in 5 ml 5% by weight of an N,N′-dimethyl foramide solution of polyacrylonitrile. The fire-retardant microtubules were encapsulated with the polyacrylonitrile by surface deposition, thereby obtaining encapsulated microencapsulated fire retardant 6.

### Preparation of Fire-Retardant Polymeric Composite Material

The encapsulated microencapsulated fire retardant 6 was blended with polyacrylonitrile in a ratio of 1:10 by weight in a solution of polyacrylonitrile in N,N′-dimethyl foramide, and dried at 80° C. to evaporate the solvent thereby obtaining fire-retardant polymeric composite material 6.

The limiting oxygen index (LOI) for each of the pure polyacrylonitrile (A), the polyacrylonitrile containing kapok tubules (B), the polyacrylonitrile with directly added chlorinated polyethylene (C), and the resultant fire-retardant polymeric composite material 6 (D) and the results of plastic fire retardation test (UL-94) are shown in the following Table 6.

It can be seen from the results of the test, the fire retardation properties of the encapsulated microencapsulated fire retardant 6 are not adversely affected and the problems associated with penetration, migration, and phase-separation during using process can be addressed.

### Example 7

### Preparation of Encapsulated Microencapsulated Fire Retardant

(1) Preparing Truncated Microtubules:

Truncate 1 g natural bamboo fiber into truncated microtubules having a length of 500˜1000 μm.

(2) Filling Natural Microtubules with a Fire Retardant Liquid:

The truncated microtubules obtained in step (1) were dispersed and immersed in a 70% (weight percentage) methanol solution of chlorinated paraffin (with a chlorine content of 65%˜70%) for 15 min to make the capillary absorption of the methanol solution of chlorinated paraffin to the microtubules reach a balance, such that the truncated microtubules were fully filled with the methanol solution of chlorinated paraffin, thereby producing fire-retardant microtubules 7.

(3) Encapsulating the Fire-Retardant Microtubules 7:

The methanol in the fire-retardant microtubules 7 was evaporated. The resultant fire-retardant microtubules 7 were immersed in a mixture liquid of 6:5 (molar ratio) phenol and formaldehyde (containing 3% by weight of oxalic acid as a catalyst). The fire-retardant microtubules were encapsulated with the phenolic resin by surface condensation-polymerization, thereby obtaining encapsulated microencapsulated fire retardant 7.

### Preparation of Fire-Retardant Polymeric Composite Material

The encapsulated microencapsulated fire retardant 7 was blended with polystyrene in a ratio of 1:5 by weight to obtain fire-retardant polymeric composite material 7.

The limiting oxygen index (LOI) for each of the pure polystyrene (A), the polystyrene containing bamboo tubules (B), the polystyrene with directly added chlorinated paraffin (C), and the resultant fire-retardant polymeric composite material 7 (D) and the results of plastic fire retardation test (UL-94) are shown in the following Table 7.

It can be seen from the results of the test, the fire retardation properties of the encapsulated microencapsulated fire retardant 3 are not adversely affected and the problems associated with penetration, migration, and phase-separation during using process can be addressed.

### Example 8

### Preparation of Encapsulated Microencapsulated Fire Retardant

(1) Preparing Truncated Microtubules:

Truncate 1 g natural kapok fiber into truncated microtubules having a length of 1000˜2000 μm.

(2) Filling Natural Microtubules with a Fire Retardant Liquid:

The truncated microtubules obtained in step (1) were dispersed and immersed in a 60% (weight percentage) ethanol solution of tri(2-chloroethyl)phosphate (with a chlorine content of 65%˜70%) for 1 hour to make the capillary absorption of the ethanol solution of tri(2-chloroethyl)phosphate (with a chlorine content of 65%˜70%) to the microtubules reach a balance, such that the truncated microtubules were fully filled with the ethanol solution of tri(2-chloroethyl) phosphate (with a chlorine content of 65%˜70%), thereby producing fire-retardant microtubules 8.

(3) Encapsulating the Fire-Retardant Microtubules 8:

The ethanol in the fire-retardant microtubules 8 was evaporated and the resultant fire-retardant microtubules were immersed in 5 ml 5% by weight of a dichloromethane solution of acetate fiber for 0.5 hours. The fire-retardant microtubules were encapsulated with the acetate fiber by surface deposition, thereby obtaining encapsulated microencapsulated fire retardant 8.

### Preparation of Fire-Retardant Polymeric Composite Material

The encapsulated microencapsulated fire retardant 8 was blended with polyurethane in a ratio of 1:8 by weight to obtain a fire-retardant polymeric composite material 8.

The limiting oxygen index (LOI) for each of the pure polyurethane (A), the polyurethane containing kapok tubules (B), the polyurethane with directly added tri(2-chloroethyl) phosphate (C), and the resultant fire-retardant polymeric composite material 8 (D) and the results of plastic fire retardation test (UL-94) are shown in the following Table 8.

It can be seen from the results of the test, the fire retardation properties of the encapsulated microencapsulated fire retardant 8 are not adversely affected and the problems associated with penetration, migration, and phase-separation during using process can be addressed.

### Example 9

### Preparation of Encapsulated Microencapsulated Fire Retardant

(1) Preparing Truncated Microtubules:

Truncate 1 g natural kapok fiber into truncated microtubules having a length of 2000˜3000 μm.

(2) Filling Natural Microtubules with a Fire Retardant Liquid:

The truncated microtubules obtained in step (1) were dispersed and immersed in a 50% (weight percentage) ethanol solution of hexabromo-cyclododecane (HBCD) (with a bromine content of 74.7%) for 0.5 hours to make the capillary absorption of the ethanol solution of hexabromo-cyclododecane to the microtubules reach a balance, such that the truncated microtubules were fully filled with the ethanol solution of hexabromo-cyclododecane, thereby producing fire-retardant microtubules 9.

(3) Encapsulating the Fire-Retardant Microtubules 9:

The ethanol in the fire-retardant microtubules 9 was evaporated and the resultant fire-retardant microtubules were immersed in 5 ml 5% by weight of a dichloromethane solution of acetate fiber. The fire-retardant microtubules were encapsulated with the acetate fiber by surface deposition, thereby obtaining encapsulated microencapsulated fire retardant 9.

### Preparation of Fire-Retardant Polymeric Composite Material

The encapsulated microencapsulated fire retardant 9 was directly added to and blended with polycarbonate in a ratio of 1:9 by weight to obtain a fire-retardant polymeric composite material 9.

The limiting oxygen index (LOI) for each of the pure polycarbonate (A), the polycarbonate containing kapok tubules (B), the polycarbonate with directly added hexabromo-cyclododecane (C), and the resultant fire-retardant polymeric composite material 9 (D) and the results of plastic fire retardation test (UL-94) are shown in the following Table 9.

It can be seen from the results of the test, the fire retardation properties of the encapsulated microencapsulated fire retardant 9 are not adversely affected and the problems associated with penetration, migration, and phase-separation during using process can be addressed.

### Example 10

### Preparation of Encapsulated Microencapsulated Fire Retardant

(1) Preparing Truncated Microtubules:

Truncate 1 g natural kapok fiber into truncated microtubules having a length of 3˜4 mm.

(2) Filling Natural Microtubules with a Fire Retardant Liquid:

The truncated microtubules obtained in step (1) were dispersed and immersed in a 80% (weight percentage) acetone solution of triphenyl phosphate for 1 hour to make the capillary absorption of the acetone solution of triphenyl phosphate to the microtubules reach a balance, such that the truncated microtubules were fully filled with the acetone solution of triphenyl phosphate, thereby producing fire-retardant microtubules 10.

(3) Encapsulating the Fire-Retardant Microtubules 10:

The acetone in the fire-retardant microtubules 10 was evaporated and the resultant fire-retardant microtubules were immersed in 2 g urea-formaldehyde prepolymer (obtained by adding 1 g urea into 2 ml 36% volume fraction aqueous formaldehyde solution and stirring until the mixture was fully dissolved, heating to 60° C., and maintaining at this temperature for 15 min), the temperature of the mixture was raised to 97-98° C. and the reaction lasted for 1 h. Urea-formaldehyde resin polymer was generated around the kapok fiber by surface phase separation and deposition, such that the fire-retardant microtubules 10 were encapsulated by the urea-formaldehyde resin, thereby obtaining encapsulated microencapsulated fire retardant 10.

### Preparation of Fire-Retardant Polymeric Composite Material

The encapsulated microencapsulated fire retardant 10 was blended with butadiene-isoprene copolymer (PIB) in a ratio of 1:9 by weight to obtain a fire-retardant polymeric composite material 10.

The limiting oxygen index (LOI) for each of the pure butadiene-isoprene copolymer (A), the butadiene-isoprene copolymer containing kapok tubules (B), the butadiene-isoprene copolymer with directly added triphenyl phosphate (C), and the resultant fire-retardant polymeric composite material 10 (D) and the results of plastic fire retardation test (UL-94) are shown in the following Table 10.

It can be seen from the results of the test, the fire retardation properties of the encapsulated microencapsulated fire retardant 10 are not adversely affected and the problems associated with penetration, migration, and phase-separation during using process can be addressed.

### Example 11

### Preparation of Encapsulated Microencapsulated Fire Retardant

(1) Preparing Truncated Microtubules:

Truncate 1 g natural flax fiber into truncated microtubules having a length of 4000˜5000 μm.

(2) Filling Natural Microtubules with a Fire Retardant Liquid:

The truncated microtubules obtained in step (1) were dispersed and immersed in a 70% (weight percentage) acetone solution of tetrabromo bisphenol A -bis(2,3-dibromopropyl)ether for 0.5 hours to make the capillary absorption of the acetone solution of tetrabromo bisphenol A bis(2,3-dibromopropyl)ether to the microtubules reach a balance, such that the truncated microtubules were fully filled with the acetone solution of tetrabromo bisphenol A, thereby producing fire-retardant microtubules 11.

(3) Encapsulating the fire-retardant microtubules 11: The acetone in the fire-retardant microtubules 11 was evaporated and the resultant fire-retardant microtubules were immersed in 2 g ethylene terephthalate oligomer (obtained by esterifying terephthalic acid with a slight excess of methanol, evaporating water, excessive methanol and low-boiling point materials such as benzoic acid, distillating the resultant mixture to obtain pure dimethyl terephthalate, elevating the temperature of the melt to 190-200° C., and conducting transesterification of the dimethyl terephthalate with ethylene glycol (in a molar ratio of about 1:2.4) with the catalysis of cadmium acetate and antimony oxide). At 283° C., the ethylene terephthalate oligomer was self-condensed and polymerized with the catalysis of antimony oxide to form a polyethylene terephthalate which encapsulates the fire-retardant microtubules 11, thereby obtaining encapsulated microencapsulated fire retardant 11.

### Preparation of Fire-Retardant Polymeric Composite Material

The encapsulated microencapsulated fire retardant 11 was blended with a melt of polycarbonate in a ratio of 1:8 by weight to obtain a fire-retardant polymeric composite material 11 by hot pressing.

The limiting oxygen index (LOI) for each of the pure polycarbonate (A), the polycarbonate containing flax tubules (B), the polycarbonate with directly added tetrabromo bisphenol A - bis(2,3-dibromopropyl)ether (C), and the resultant fire-retardant polymeric composite material 11 (D) and the results of plastic fire retardation test (UL-94) are shown in the following Table 11.

It can be seen from the results of the test, the fire retardation properties of the encapsulated microencapsulated fire retardant 11 are not adversely affected and the problems associated with penetration, migration, and phase-separation during using process can be addressed.

### Example 12

### Preparation of Encapsulated Microencapsulated Fire Retardant

(1) Preparing Truncated Microtubules:

Truncate 1 g natural kapok fiber into truncated microtubules having a length of 5000˜10000 μm.

(2) Filling Natural Microtubules with a Fire Retardant Liquid:

The truncated microtubules obtained in step (1) were dispersed and immersed in a 80% (weight percentage) acetone solution of Reogard1000 for 1 hour to make the capillary absorption of fire retardant liquid to the microtubules reach a balance, such that the truncated microtubules were fully filled with the acetone solution of Reogard1000, thereby producing fire-retardant microtubules 12.

(3) Encapsulating the Fire-Retardant Microtubules 12:

The acetone in the fire-retardant microtubules 12 was evaporated and the resultant fire-retardant microtubules were immersed in 2 g urea-formaldehyde prepolymer (obtained by adding 1 g urea into 2 ml 36% volume fraction aqueous formaldehyde solution and stirring until the mixture was fully dissolved, heating to 60° C., and maintaining at this temperature for 15 min), the temperature of the mixture was raised to 97-98° C. and the reaction lasted for 1 h. Urea-formaldehyde resin polymer was generated around the kapok fiber by surface phase separation and deposition, such that the fire-retardant microtubules 12 were encapsulated by the urea-formaldehyde resin, thereby obtaining encapsulated microencapsulated fire retardant 12.

### Preparation of Fire-Retardant Polymeric Composite Material

The encapsulated microencapsulated fire retardant 12 was blended into polypropylene in a ratio of 1:7 by weight to obtain a fire-retardant polymeric composite material 12 by injection molding.

The limiting oxygen index (LOI) for each of the pure polypropylene (A), the polypropylene containing kapok tubules (B), the polypropylene with directly added Reogard1000 (C), and the resultant fire-retardant polymeric composite material 12 (D) and the results of plastic fire retardation test (UL-94) are shown in the following Table 12.

It can be seen from the results of the test, the fire retardation properties of the encapsulated microencapsulated fire retardant 12 are not adversely affected and the problems associated with penetration, migration, and phase-separation during using process can be addressed. Example 13

### Preparation of Encapsulated Microencapsulated Fire Retardant

(1) Preparing Truncated Microtubules:

Truncate 1 g natural flax fiber into truncated microtubules having a length of 50˜500 μm.

(2) Filling Natural Microtubules with a Fire Retardant Liquid:

The truncated microtubules obtained in step (1) were dispersed and immersed in a 90% (weight percentage) acetone solution of Exolit RP for 1.5 hours to make the capillary absorption of the acetone solution of Exolit RP to the microtubules reach a balance, such that the truncated microtubules were fully filled with the acetone solution of Exolit RP, thereby producing fire-retardant microtubules 13.

(3) Encapsulating the Fire-Retardant Microtubules 13:

The acetone in the fire-retardant microtubules 13 was evaporated and the resultant fire-retardant microtubules were placed in a solution of bis(4-chlorophenyl)sulfone and sodium sulfide in N-methylpyrrolidone (1:1:1). Polymerization was conducted at 260-220° C. for 2-8 h to allow the fire-retardant microtubules 13 to be encapsulated by polyphenylene sulfide resin, thereby obtaining encapsulated microencapsulated fire retardant 13.

### Preparation of Fire-Retardant Polymeric Composite Material

The encapsulated microencapsulated fire retardant 13 was blended into PA66 in a ratio of 1:5 by weight to obtain a fire-retardant polymeric composite material 13 by injection molding.

The limiting oxygen index (LOI) for each of the pure PA66 (A), the PA66 containing flax tubules (B), the PA66 with directly added Exolit RP (C), and the resultant fire-retardant polymeric composite material 13 (D) and the results of plastic fire retardation test (UL-94) are shown in the following Table 13.

It can be seen from the results of the test, the fire retardation properties of the encapsulated microencapsulated fire retardant 13 are not adversely affected and the problems associated with penetration, migration, and phase-separation during using process can be addressed.

### Example 14

### Preparation of Encapsulated Microencapsulated Fire Retardant

(1) Preparing Truncated Microtubules:

Truncate 1 g natural milkweed fiber into truncated microtubules having a length of 50˜200 μm.

(2) Filling Natural Microtubules with a Fire Retardant Liquid:

The truncated microtubules obtained in step (1) were dispersed and immersed in a 90% (weight percentage) acetone solution of SaFRon for 2 hours to make the capillary absorption of the acetone solution of SaFRon to the microtubules reach a balance, such that the truncated microtubules were fully filled with the acetone solution of SaFRon, thereby producing fire-retardant microtubules 14.

(3) Encapsulating the Fire-Retardant Microtubules 14:

The acetone in the fire-retardant microtubules 14 was evaporated and the resultant fire-retardant microtubules were immersed in 2 g alkyd resin prepolymer (obtained by co-heating dry oil and glycerol at 240° C. and conducting alcoholysis and transesterification with a transesterification catalyst to form glycerol mono-ester or diol). Phthalic anhydride was added into the reaction to conduct co-condensation-esterification at the same temperature as mentioned above, so as to allow the fire-retardant microtubules 14 to be encapsulated by an alkyd resin, thereby obtaining encapsulated microencapsulated fire retardant 14.

### Preparation of Fire-Retardant Polymeric Composite Material

The encapsulated microencapsulated fire retardant 14 was blended into PET in a ratio of 1:9 by weight to obtain a fire-retardant polymeric composite material 14 by injection molding.

The limiting oxygen index (LOI) for each of the pure PET (A), the PET containing milkweed tubules (B), the PET with directly added SaFRon (C), and the resultant fire-retardant polymeric composite material 14 (D) and the results of plastic fire retardation test (UL-94) are shown in the following Table 14.

It can be seen from the results of the test, the fire retardation properties of the encapsulated microencapsulated fire retardant 14 are not adversely affected and the problems associated with penetration, migration, and phase-separation during using process can be addressed.

### Example 15

### Preparation of Encapsulated Microencapsulated Fire Retardant

(1) Preparing Truncated Microtubules:

Truncate 1 g natural Kapok fiber into truncated microtubules having a length of 100˜500 μm.

(2) Filling Natural Microtubules with a Fire Retardant Liquid:

The truncated microtubules obtained in step (1) were dispersed and immersed in a 70% (weight percentage) acetone solution of tri(2,3-dibromopropyl)isocyanurate (TBC) for 0.5 hours to make the capillary absorption of the acetone solution of TBC to the microtubules reach a balance, such that the truncated microtubules were fully filled with the acetone solution of TBC, thereby producing fire-retardant microtubules 15.

(3) Encapsulating the Fire-Retardant Microtubules 15:

The acetone in the fire-retardant microtubules 15 was evaporated and the resultant fire-retardant microtubules were immersed in 2 g ethylene terephthalate oligomer (obtained by esterifying 2 ml terephthalic acid with a slight excess of methanol, evaporating water, excessive methanol and low-boiling point materials such as benzoic acid, distillating the resultant mixture to obtain pure dimethyl terephthalate, elevating the temperature of the melt to 190-200° C., and conducting transesterification of the dimethyl terephthalate with ethylene glycol (in a molar ratio of about 1:2.4) with the catalysis of cadmium acetate and antimony oxide). At 283° C., the ethylene terephthalate oligomer was self-condensed and polymerized with the catalysis of antimony oxide to form a polyethylene terephthalate which encapsulates the fire-retardant microtubules 15, thereby obtaining encapsulated microencapsulated fire retardant 15.

### Preparation of Fire-Retardant Polymeric Composite Material

The encapsulated microencapsulated fire retardant 15 was blended into styrene-butadiene-styrene block copolymer (SBS) in a ratio of 1:8 by weight to obtain a fire-retardant polymeric composite material 15 by injection molding.

The limiting oxygen index (LOI) for each of the pure styrene-butadiene-styrene block copolymer (A), the styrene-butadiene-styrene block copolymer containing kapok tubules (B), the styrene-butadiene-styrene block copolymer with directly added TBC (C), and the resultant fire-retardant polymeric composite material 15 (D) and the results of plastic fire retardation test (UL-94) are shown in the following Table 15.

It can be seen from the results of the test, the fire retardation properties of the encapsulated microencapsulated fire retardant 15 are not adversely affected and the problems associated with penetration, migration, and phase-separation during using process can be addressed.

### Example 16

### Preparation of Encapsulated Microencapsulated Fire Retardant

(1) Preparing Truncated Microtubules:

Truncate 1 g natural kapok fiber into truncated microtubules having a length of 10˜300 μm.

(2) Filling Natural Microtubules with a Fire Retardant Liquid:

The truncated microtubules obtained in step (1) were dispersed and immersed in a 60% (weight percentage) ethanol solution of 1,2,3,4-tetrabromobutane for 0.5 hours to make the absorption of the ethanol solution of 1,2,3,4-tetrabromobutane to the microtubules reach a balance, such that the truncated microtubules were fully filled with the ethanol solution of 1,2,3,4-tetrabromobutane, thereby producing fire-retardant microtubules 16.

(3) Encapsulating the Fire-Retardant Microtubules 16:

The ethanol in the fire-retardant microtubules 16 was evaporated and the resultant fire-retardant microtubules were placed in a solution of bis(4-chlorophenyl)sulfone and sodium sulfide in N-methylpyrrolidone (1:1:1). Polymerization was conducted at 260-220° C. for 2-8 h to allow the fire-retardant microtubules 13 to be encapsulated by polyphenylene sulfide resin, thereby obtaining encapsulated microencapsulated fire retardant 16.

### Preparation of Fire-Retardant Polymeric Composite Material

The encapsulated microencapsulated fire retardant 16 was blended into a melt of polyoxymethylene (POM) in a ratio of 1:5 by weight to obtain a fire-retardant polymeric composite material 16 by injection molding.

The limiting oxygen index (LOI) for each of the pure polyoxymethylene (A), the polyoxymethylene containing kapok tubules (B), the polyoxymethylene with directly added 1,2,3,4-tetrabromobutane (C), and the resultant fire-retardant polymeric composite material 16 (D) and the results of plastic fire retardation test (UL-94) are shown in the following Table 16.

It can be seen from the results of the test, the fire retardation properties of the encapsulated microencapsulated fire retardant 16 are not adversely affected and the problems associated with penetration, migration, and phase-separation during using process can be addressed.

TABLE 1

| | | Plastic fire |
|---|---|---|
| | Limiting oxygen | retardation test |
| Sample | index (LOI)/% | (UL-94) |
| A | 18 | FH-3 |
| B | 17 | FH-3 |
| C | 28 | V-0 |
| D | 32 | V-0 |

TABLE 2

| | | Plastic fire |
|---|---|---|
| | Limiting oxygen | retardation test |
| Sample | index (LOI)/% | (UL-94) |
| A | 19 | FH-3 |
| B | 18 | FH-3 |
| C | 28 | V-0 |
| D | 32 | V-0 |

TABLE 3

| | | Plastic fire |
|---|---|---|
| | Limiting oxygen | retardation test |
| Sample | index (LOI)/% | (UL-94) |
| A | 18 | FH-3 |
| B | 17 | FH-3 |
| C | 28 | V-0 |
| D | 32 | V-0 |

TABLE 4

| | | Plastic fire |
|---|---|---|
| | Limiting oxygen | retardation test |
| Sample | index (LOI)/% | (UL-94) |
| A | 20 | FH-3 |
| B | 19 | FH-3 |
| C | 29 | V-0 |
| D | 33 | V-0 |

TABLE 5

| | | Plastic fire |
|---|---|---|
| | Limiting oxygen | retardation test |
| Sample | index (LOI)/% | (UL-94) |
| A | 18 | FH-3 |
| B | 17 | FH-3 |
| C | 28 | V-0 |
| D | 32 | V-0 |

TABLE 6

| | | Plastic fire |
|---|---|---|
| | Limiting oxygen | retardation test |
| Sample | index (LOI)/% | (UL-94) |
| A | 19 | FH-3 |
| B | 18 | FH-3 |
| C | 29 | V-0 |
| D | 34 | V-0 |

TABLE 7

| | | Plastic fire |
|---|---|---|
| | Limiting oxygen | retardation test |
| Sample | index (LOI)/% | (UL-94) |
| A | 17 | FH-3 |
| B | 16 | FH-3 |
| C | 29 | V-0 |
| D | 33 | V-0 |

TABLE 8

| | | Plastic fire |
|---|---|---|
| | Limiting oxygen | retardation test |
| Sample | index (LOI)/% | (UL-94) |
| A | 18 | FH-3 |
| B | 17 | FH-3 |
| C | 29 | V-0 |
| D | 33 | V-0 |

TABLE 9

| | | Plastic fire |
|---|---|---|
| | Limiting oxygen | retardation test |
| Sample | index (LOI)/% | (UL-94) |
| A | 17 | FH-3 |
| B | 16 | FH-3 |
| C | 28 | V-0 |
| D | 31 | V-0 |

TABLE 10

| | | Plastic fire |
|---|---|---|
| | Limiting oxygen | retardation test |
| Sample | index (LOI)/% | (UL-94) |
| A | 19 | FH-3 |
| B | 18 | FH-3 |
| C | 30 | V-1 |
| D | 34 | V-1 |

TABLE 11

| | | Plastic fire |
|---|---|---|
| | Limiting oxygen | retardation test |
| Sample | index (LOI)/% | (UL-94) |
| A | 17 | FH-3 |
| B | 16 | FH-3 |
| C | 29 | V-0 |
| D | 32 | V-0 |

TABLE 12

| | | Plastic fire |
|---|---|---|
| | Limiting oxygen | retardation test |
| Sample | index (LOI)/% | (UL-94) |
| A | 17 | FH-3 |
| B | 16 | FH-3 |
| C | 30 | V-0 |
| D | 33 | V-0 |

TABLE 13

| | | Plastic fire |
|---|---|---|
| | Limiting oxygen | retardation test |
| Sample | index (LOI)/% | (UL-94) |
| A | 19 | FH-3 |
| B | 18 | FH-3 |
| C | 30 | V-0 |
| D | 34 | V-0 |

TABLE 14

| | | Plastic fire |
|---|---|---|
| | Limiting oxygen | retardation test |
| Sample | index (LOI)/% | (UL-94) |
| A | 18 | FH-3 |
| B | 17 | FH-3 |
| C | 29 | V-0 |
| D | 33 | V-0 |

TABLE 15

| | | Plastic fire |
|---|---|---|
| | Limiting oxygen | retardation test |
| Sample | index (LOI)/% | (UL-94) |
| A | 19 | FH-3 |
| B | 18 | FH-3 |
| C | 30 | V-0 |
| D | 34 | V-0 |

TABLE 16

| | | Plastic fire |
|---|---|---|
| | Limiting oxygen | retardation test |
| Sample | index (LOI)/% | (UL-94) |
| A | 16 | FH-3 |
| B | 16 | FH-3 |
| C | 28 | V-0 |
| D | 31 | V-0 |

We claim:

1. A microencapsulated fire retardant comprising a core and a shell for encapsulating the core, wherein the core comprises a fire retardant agent and the shell is a natural microtubule.

2. The microencapsulated fire retardant of claim 1 wherein the natural microtubule is selected from the group consisting of kapok fiber, milkweed fiber, luffa fiber, bamboo fiber, tex bamboo fiber, flax fiber, wool, and down.

3. The microencapsulated fire retardant of claim 1 wherein the natural microtubule has a length from 10 μm˜1 cm.

4. The microencapsulated fire retardant of claim 1 wherein the fire retardant agent is selected from the group consisting of decabromo-diphenylether, tetrabromo bisphenol A, octabromoether, decabromo-diphenyl ethane, tetrabromoether, bromo polystyrene, hexabromo-cyclododecane, chlorinated paraffin, Dechlorane Plus, chlorinated polyethylene, decabromo diphenyl ether, decabromo diphenyl ethane, octabromo diphenyl ether, bromo-polystyrene, pentabromo diphenyl ether, 2,2-di(chloromethyl)cyclopropane, ammonium chloride, bromo epoxy resin, dibromo-neopentyl-glycol, dibromo-neopentyl-glycol phosphate, dibromo-neopentyl-glycol phosphate cyanamide, hexabromo cyclododecane, tribromo phenol, tetrabromo phthalic anhydride, bis(2,3-dibromopropyl)fumarate, phenoxy tetrabromo bisphenol A carbonate, 1,2,3,4-tetrabromo butane, (2,3-dibromopropyl)fumarate, 1,3-bis(2,4,6-tribromo-phenox)isopropanol, antimony trichloride, 1,2-bis(2,4,6-tribromophenoxy)ethane, 4,4′-isopropylidene bis(2,6-dibromophenol) 2,3-dibromo-1-propanol, an unsaturated ester of tetrachloro phthalic anhydride, phenoxy tetrabromo bisphenol A carbonate oligomer, bis(2,3-dibromopropyl)fumarate, red phosphorus, tri(2-chloroethyl)phosphate, tri(2-chloropropyl)phosphate, tri(2,3-dichloropropyl)phosphate, mono-ammonium phosphate, di-ammonium phosphate, triphenyl phosphate, ammonium polyphosphate, pentaerythritol, melamine phosphate, tri(2,3-dibromopropyl)phosphate, tetrakis(hydroxymethyl)phosphonium chloride, cyclic phosphate derivatives, phosphorus-containing polyol polyether, tri(chloroethyl)phosphate, zinc phosphate, trimethyl phosphonate, trimethyl phosphate, guanidine phosphate, ammonium dihydrogen phosphate, diammonium hydrogen phosphate, tribenzyl phosphate, melamine polyphosphate (salt), triphenyl phosphine, ethylene di(tetrabromo phthalimide), tri(β-chloroethyl)phosphate, tri(2-chloropropyl)phosphate, tri(1,3-dichloropropyl)phosphate, dimethyl methylphosphate, tri(bromophenyl)phosphate (PB-460), DG-9021, melamine and the salts thereof, dicyanamide, guanidine salts, melamine phosphate salts, melamine cyanurate (MCA), magnesium hydroxide, aluminum hydroxide, antimony(III) oxide, zinc borate, low hydrate zinc borate, ferrocene, boric acid, hexabromo cyclododecane (HBCD) -melamine cyanurate, isopropyl phenyl diphenyl phosphate, poly(phenylene oxide), poly(tetrafluoro ethylene) fine powder, hydrotalcite, brucite, organic soil, diisopropyl benzene oligomer, sodium antimonate, and calcium chloride, and a mixture thereof.

5. The microencapsulated fire retardant of claim 1 further comprising an encapsulation layer formed from a synthetic polymer or natural fiber.

6. The microencapsulated fire retardant of claim 5 wherein the synthetic polymer is selected from the group consisting of polyethylene, polypropylene, polybutylene, polystyrene, polyvinyl chloride, polyisobutylene, polyacrylonitrile, polyurethane, polymethyl methacrylate, polymethyl acrylate, polyvinyl acetate, polyethylene terephthalate, polybutylene terephthalate, alkyd resin, polycarbonate, urea-formaldehyde resin, melamine-formaldehyde resin, melamine-urea-formaldehyde resin, phenolic resin, epoxy resin, polyoxymethylene, polyethylene oxide, polyphenylene sulfide, hexamethylene adipamide polymer, polycaprolactam, polyimide, polydimethyl siloxane, acrylonitrile-butadiene-styrene copolymer, styrene-butadiene-styrene block copolymer, isobutylene-isoprene rubber, and butadiene-isoprene copolymer, or a mixture thereof.

7. The microencapsulated fire retardant of claim 5 wherein natural fiber is selected from the group consisting of cotton fiber, bast fiber, xylem fiber, grass fiber, and acetate fiber, and a mixture thereof.

8. A method for producing the microencapsulated fire retardant as claimed in any of claims 1 to 7 comprising using natural microtubules to absorb a fire retardant agent and optionally encapsulating the natural microtubules that have absorbed the fire retardant agent with a synthetic polymer or a natural fiber to produce the microencapsulated fire retardant.

9. A fire-retardant polymeric composite material comprising the microencapsulated fire retardant as claimed in any of claims 1 to 7 and a polymeric substrate material.

10. The fire-retardant polymeric composite material of claim 9 wherein the polymeric substrate material is selected from the group consisting of a polyolefin resin, poly(meth)acrylate ester, polyester, polystyrene, polyvinyl chloride, polyacrylonitrile, polyurethane, polyvinyl acetate, polycarbonate, urea-formaldehyde resin, melamine-formaldehyde resin, melamine-urea-formaldehyde resin, phenolic resin, epoxy resin, polyoxymethylene, polyethylene oxide, hexamethylene adipamide polymer, polycaprolactam, polyimide, polydimethyl siloxane, acrylonitrile-butadiene-styrene copolymer, styrene-butadiene-styrene block copolymer, isobutylene-isoprene rubber, and butadiene-isoprene copolymer, and a mixture thereof.
